(19) United States
(12) Patent Application Publication
(10) Pub. No.: US 2020/0049372 A1
(43) Pub. Date: Feb. 13, 2020

(54) Air-conditioning Drain Sanitation Device and System

(71) Applicant: Todd E. Thompson, Bradenton, FL (US)

(72) Inventor: Todd E. Thompson, Bradenton, FL (US)

(21) Appl. No.: 16/059,545

(22) Filed: Aug. 9, 2018

(51) Int. Cl. F24F 13/22; C02F 1/50; C02F 1/68

(52) U.S. Cl. CPC F24F 13/222; C02F 1/50; C02F 1/685; F24F 2221/225; C02F 2303/04; C02F 2303/20; F24F 2013/228

(57) ABSTRACT

An air-conditioning drain line sanitation system includes: an air-conditioning unit with a drain emission connector; a drain line, and an air-conditioning drain line sanitation device, including a line connector with a connector pipe segment and a container connector, and a container with an outer enclosure and an inner container with a sanitation composition, such that the air-conditioning drain line sanitation device mixes condensate fluid emitted from the drain emission connector with the sanitation composition, such that the sanitation composition sanitizes the condensate fluid and the drain line, whereby a risk of clogging the drain line is reduced.

### CROSS-REFERENCE TO RELATED APPLICATIONS

N/A.

### FIELD OF THE INVENTION

The present invention relates generally to the field of air-conditioning system, and more particularly to methods and systems for maintaining air-conditioning drain lines in a sanitized state.

### BACKGROUND OF THE INVENTION

Air-conditioning systems are ubiquitous in the United States for both residential and commercial use.

However, in continued use air-conditioning drain lines may develop internal growth bacteria, algae, and/or fungus, which can cause the drain to become clogged and thereby cause damage to housing parts and structures, and also cause emission of unpleasant odors.

As such, considering the foregoing, it may be appreciated that there continues to be a need for novel and improved devices and methods for maintaining air-conditioning drain lines in a sanitized state.

### SUMMARY OF THE INVENTION

The foregoing needs are met, to a great extent, by the present invention, wherein in aspects of this invention, enhancements are provided to the existing model of air-conditioning drain line maintenance and sanitation.

In an aspect, an air-conditioning drain line sanitation system can:
a) an air-conditioning unit, including a drain emission connector that emits a condensate fluid from the air-conditioning unit during operation;
b) a drain line with a hollow interior to allow the condensate fluid to flow away from the air-conditioning; and
c) an air-conditioning drain line sanitation device, which includes a container with a sanitation composition, wherein the container is removably attached to the air-conditioning drain line sanitation device;
wherein the air-conditioning drain line sanitation device can be connected between an outer end of the drain emission connector and a first end of the drain line to create a fluid connection between the drain emission connector and the drain line; wherein the air-conditioning drain line sanitation device is configured to mix the condensate fluid emitted from the drain emission connector with the sanitation composition, such that the sanitation composition sanitizes the condensate fluid and the drain line, whereby a risk of clogging the drain line is reduced.

In a related aspect, the air-conditioning drain line sanitation device can further include a line connector, including:
a) a connector pipe segment, comprising inner and outer ends, and a connector aperture in a bottom side of the connector pipe segment;
b) a container connector, which can be connected to the bottom side of the connector pipe segment, around the connector aperture;
wherein the container can be removably attached to the container connector, such that an interior of the container is in fluid contact with the connector pipe segment via the connector aperture.

In another related aspect, the container can further include:
a) an outer enclosure, such that an upper end of the outer enclosure is configured to detachably connect to a lower end of the container connector to create a tight lock; and optionally
b) an inner container, which comprises an upper opening and the interior that is accessible via the upper opening, such that the inner container is configured to slide into the outer enclosure;
such that the condensate fluid flows via the upper opening of the inner container into the interior, such that the condensate fluid mixes with the sanitation composition;
whereby a flow of condensate fluid past the connector aperture in the connector pipe segment causes the condensate fluid mixed with the sanitation composition to flow back into the connector pipe segment and subsequently into the drain line.

In a further related aspect, the container can further include:
a sealing plate, which is locked in place on top of the inner container between the outer enclosure and the inner container, such that the sealing plate comprises sealing apertures, to allow the condensate fluid to flow via the sealing apertures and the upper opening of the inner container into the interior.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating an air-conditioning drain line sanitation system, according to an embodiment of the invention.

FIG. 2A is a perspective view of an air-conditioning drain line sanitation device, according to an embodiment of the invention.

FIG. 2B is a perspective view of an air-conditioning drain line sanitation device, according to an embodiment of the invention.

FIG. 2C is a perspective view of an inner container of an air-conditioning drain line sanitation device, according to an embodiment of the invention.

FIG. 3 is a perspective view of an air-conditioning drain line sanitation device in an opened state, according to an embodiment of the invention.

FIG. 4 is a side view of an air-conditioning drain line sanitation device in an opened state, according to an embodiment of the invention.

FIG. 5 is a front view of an air-conditioning drain line sanitation device in an opened state, according to an embodiment of the invention.

FIG. 6A is a cross-sectional view of an air-conditioning drain line sanitation device, according to an embodiment of the invention.

FIG. 6B is a cross-sectional view of an air-conditioning drain line sanitation device, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

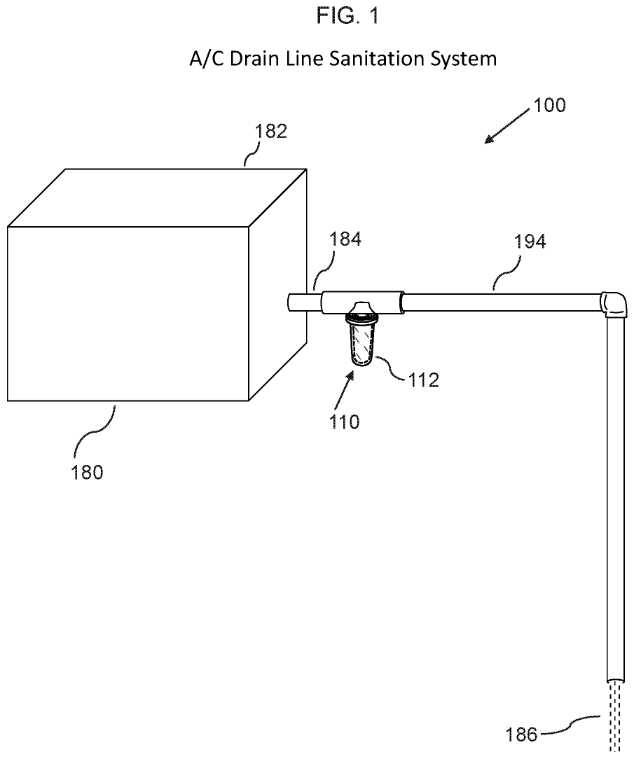

In the following, we describe the structure of an embodiment of an air-conditioning drain line sanitation system 100 with reference to FIG. 1, in such manner that like reference numerals refer to like components throughout; a convention that we shall employ for the remainder of this specification.

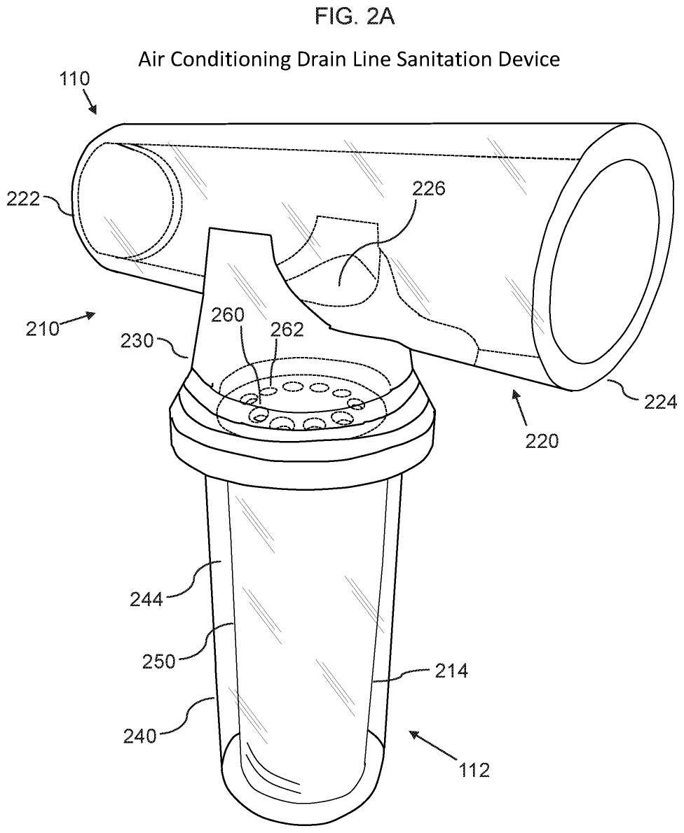

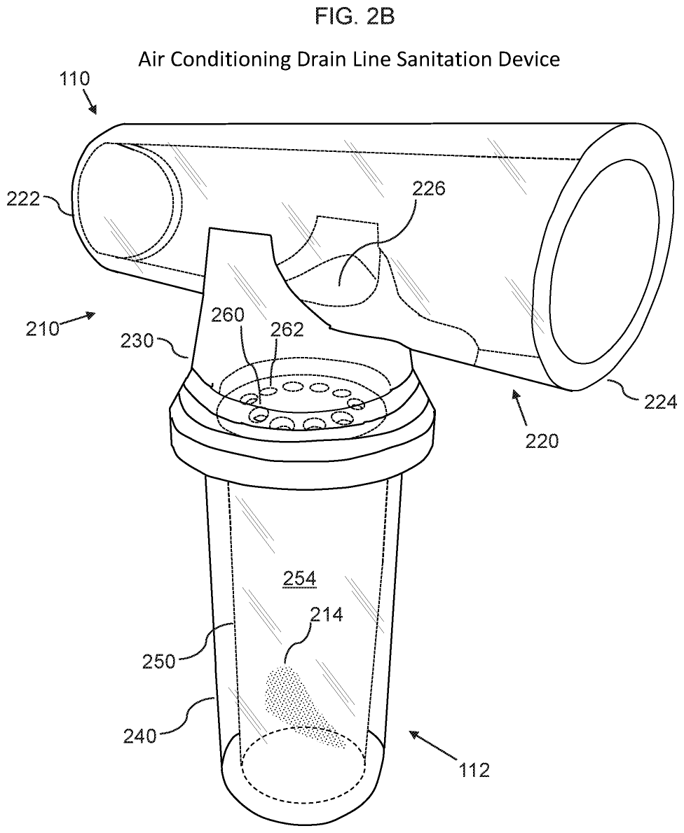

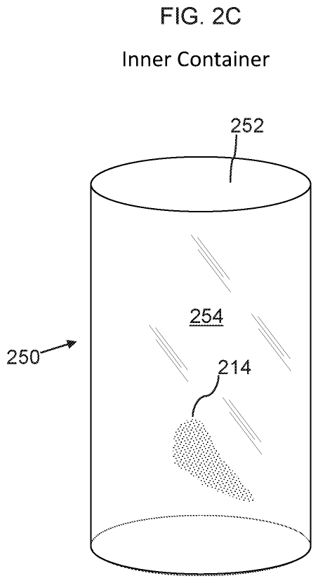

In an embodiment, as shown in FIG. 1, an air-conditioning drain line sanitation system 100 can include:
a) an air-conditioning unit 180, comprising an air-conditioning enclosure 182 and a drain emission connector 184 positioned on a side of the air-conditioning enclosure 182, such that the drain emission connector 184 is configured to emit a condensate fluid 186 from the air-conditioning unit 180 during operation of the air-conditioning unit 180;
b) A drain line 194 which is configured with a hollow interior to allow the condensate fluid 186 to flow away from the air-conditioning unit 180 via the drain line 194; and
c) an air-conditioning drain line sanitation device 110, which comprises a container 112, which comprises a sanitation composition 214, as shown in FIG. 2;
wherein the air-conditioning drain line sanitation device 110 is connected between an outer end of the drain emission connector 184 and a first end of the drain line 194 to create a fluid connection between the drain emission connector 184 and the drain line 194; wherein the air-conditioning drain line sanitation device 110 is configured to mix the condensate fluid 186 emitted from the drain emission connector 184 with the sanitation composition 214 such that the sanitation composition 214 sanitizes the condensate fluid 186 and the drain line 194, whereby a risk of clogging of the drain line 194 is reduced. The condensate fluid 186 can generally be water but contain debris and contaminants. Installation of the air-conditioning drain line sanitation device 110 will in general not impede the current flow rate or performance of the drain line 194.

In related embodiments, use of the air-conditioning drain line sanitation device 110 is not restricted to use on air-conditioning units 180 and systems, but can be installed for any drain line in HVAC systems or other systems from which fluids are emitted, or can be used for any pipe installation with fluid flow, such as industrial pipe systems, for example in the food or chemical industries. The line sanitation device 110 can be used with gravity fed, low flow, or non-pressurized flow pipe lines.

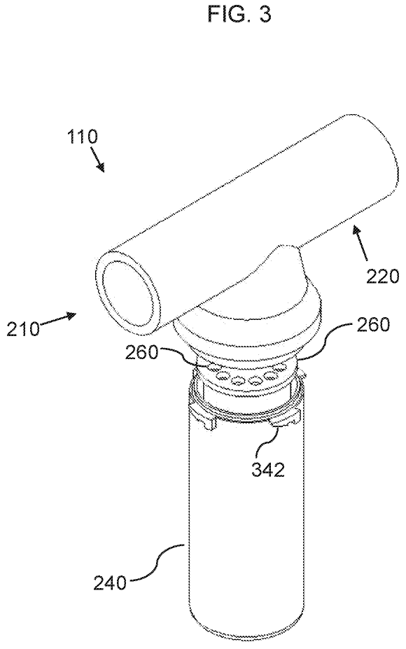

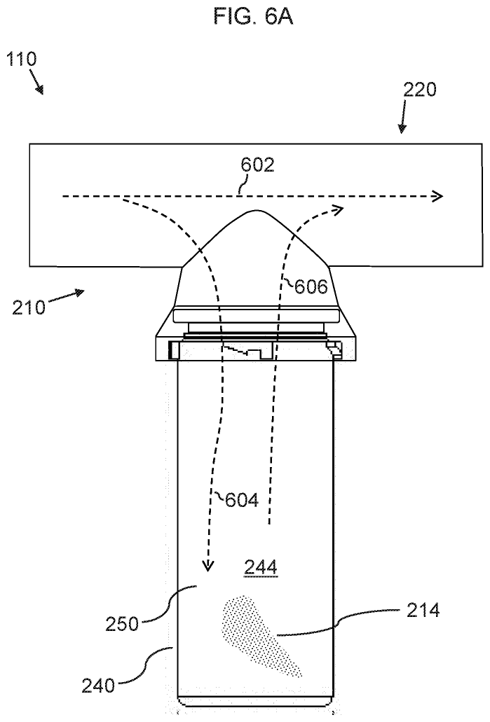

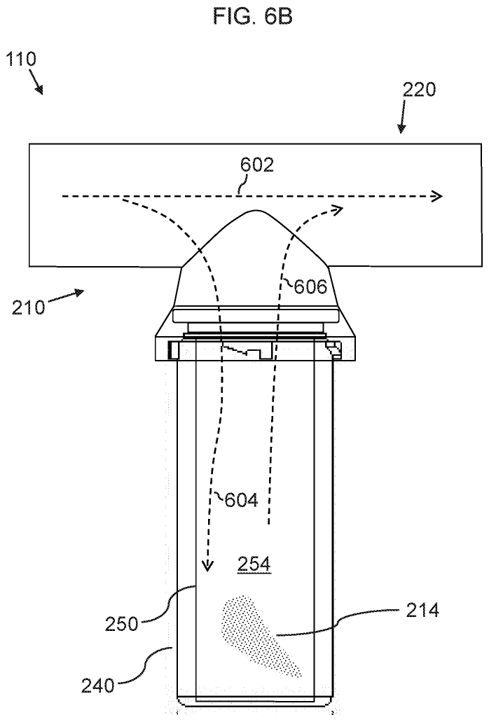

In a related embodiment, as shown in FIG. 2A, an air-conditioning drain line sanitation device 110 can include:
a) a line connector 210, which is configured as a tee pipe fitting, such that the line connector 210 can include:
   i. a connector pipe segment 220, including inner and outer ends 222 224, and a connector aperture 226 in a bottom side of the connector pipe segment 220; and
   ii. a container connector 230, which is connected to the bottom side of the connector pipe segment, around the connector aperture 226
b) a container 112, which is configured to be removably attachable to the container connector 230, for example via a snap lock and/or screw on fitting, such that an interior of the container is in fluid contact with the connector pipe segment 220 via the connector aperture 226, wherein the interior of the container 112 is configured to contain a sanitation composition 214, such that the container 112 can include:
   i. an outer enclosure 240, such that an upper end of the outer enclosure 240 is configured to detachably connect to a lower end of the container connector 230 to create a tight lock, for example such that the upper end of the outer enclosure 240 is configured with an enclosure connector 342, such as a snap-lock connector 342 with snap lock tabs 342, as shown in FIG. 3, that can lock into the lower end of the container connector 230. The connection of the outer enclosure is air tight and integrates into existing pressurized operation of the condensate drain line 194;
   ii. a sanitation composition 214, which can be positioned in an interior 244 of the outer enclosure 240. As shown in FIG. 2A, the sanitation composition 214 can be configured as one tablet 214, which for example can be a cylindrical tablet 214, such that the tablet 214 is configured to fit inside the outer enclosure 240; and
   iii. a sealing plate 260, which is locked in place on top of the outer enclosure 240 between the lower end of the container connector 230 and the outer enclosure 240, such that the sealing plate 260 comprises sealing apertures 262, to allow the condensate fluid 186 to flow via the apertures into 604 the interior 244, as shown in FIG. 6A, such that the condensate fluid 186 mixes with the sanitation composition 214;
   whereby, as shown in FIG. 6A, the flow 602 of condensate fluid 186 past the connector aperture 226 will create a drag which causes the condensate fluid 186 mixed with the sanitation composition 214 to flow back 606 into the drain line 190.

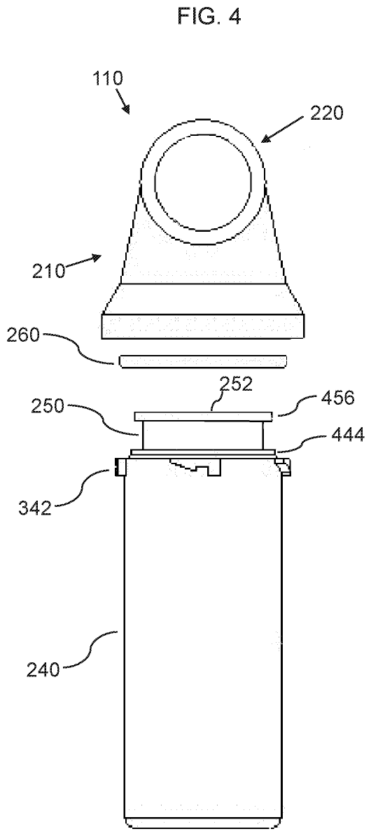

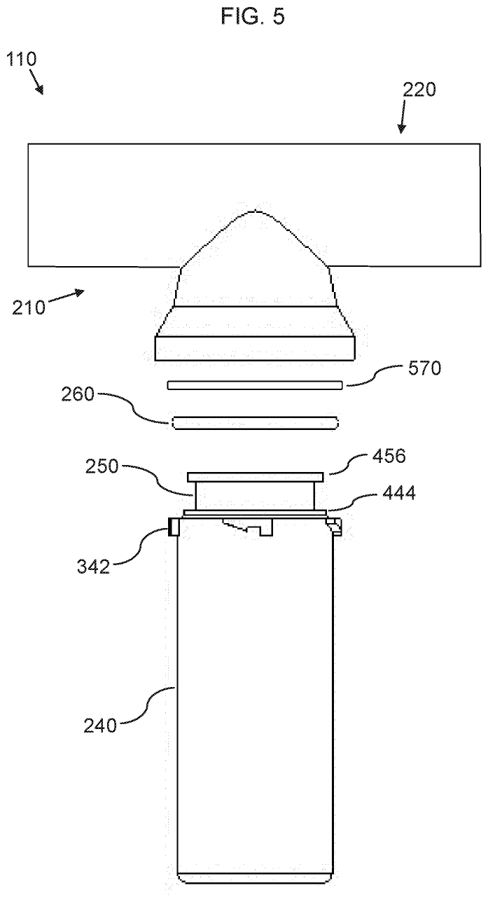

In a related embodiment, as shown in FIG. 2B, an air-conditioning drain line sanitation device 110 can include:
a) a line connector 210, which can be configured as a tee pipe fitting, such that the line connector 210 can include:
   i. a connector pipe segment 220, including inner and outer ends 222 224, and a connector aperture 226 in a bottom side of the connector pipe segment 220; and
   ii. a container connector 230, which is connected to the bottom side of the connector pipe segment, around the connector aperture 226
b) a container 112, which is configured to be removably attachable to the container connector 230, for example via a snap lock and/or screw on fitting, such that an interior of the container is in fluid contact with the connector pipe segment 220 via the connector aperture 226, wherein the interior of the container 112 is configured to contain a sanitation composition 214, such that the container 112 can include:
   i. an outer enclosure 240, such that an upper end of the outer enclosure 240 is configured to detachably connect to a lower end of the container connector 230 to create a tight lock, for example such that the upper end of the outer enclosure 240 is configured with an enclosure connector 342, such as a snap-lock connector 342 with snap lock tabs 342, as shown in FIG. 3, that can lock into the lower end of the container connector 230. The connection of the outer enclosure is air tight and integrates into existing pressurized operation of the condensate drain line 194;
   ii. an inner container 250, as shown in FIGS. 2B and 2C, that includes an upper opening 252 and an interior 254 that is accessible via the upper opening 252, wherein the inner container 250 can include an upper lip 456, as shown in FIGS. 4 and 5, such that the inner container 250 is configured to slide into the outer enclosure 240, such that the upper lip rests on an upper rim 444 of the outer enclosure;
   iii. a sanitation composition 214, which can be positioned in the interior 254 of the inner container 250; and
   iv. a sealing plate 260, which is locked in place on top of the inner container 250 between the outer enclosure 240 and the inner container 250, such that the sealing plate 260 comprises sealing apertures 262, to allow the condensate fluid 186 to flow via the apertures and the upper opening of the inner container 250 into 604 the interior 254, as shown in FIG. 6B, such that the condensate fluid 186 mixes with the sanitation composition 214;
whereby, as shown in FIG. 6B, the flow 602 of condensate fluid 186 past the connector aperture 226 will create a drag which causes the condensate fluid 186 mixed with the sanitation composition 214 to flow back 606 into the drain line 194.

In a related embodiment, as shown in FIG. 5, the container 112 can further include an O-ring 570, which is mounted between the outer enclosure 240, such that an upper end of the outer enclosure 240 is configured to detachably connect to a lower end of the container connector 230 to create a tight lock.

In a related embodiment, the sealing apertures 262 can each have a diameter in a range of for example of 0.1 to 10 mm or 0.5 to 10 mm.

In a related embodiment, as shown in FIG. 2B, the line connector 210, the outer enclosure 240 and/or the inner container 250 can be made of a transparent material such that the air-conditioning drain line sanitation device 110 provides visibility to the flow of condensate fluid 186. The transparent material can be a transparent plastic material, such as for example polymethylmethacrylate, cellulose acetate butyrate, polycarbonate, or glycol modified polyethylene terephthalate.

In related embodiments, the sanitation composition 214 can be:
a) a powder composition 214, which can be water soluble, such that the powder composition 214 dissolves in the condensate fluid 186, such that the powder composition 214 can be configured to comprise cleaning and/or antimicrobial/disinfectant agents/materials;
b) a granulate composition 214, which can be water soluble, such that the granulate composition 214 dissolves in the condensate fluid 186, such that the granulate composition 214 can be configured to comprise cleaning and/or antimicrobial/disinfectant agents/materials;
c) blocks/pellets/tablets 214 of a compressed powder/granulate composition 214, which can be water soluble, such that the blocks/pellets/tablets 214 dissolve in the condensate fluid 186, such that the blocks/pellets 214 can be configured to comprise cleaning and/or antimicrobial/disinfectant agents/materials;
d) a liquid composition 214, which can be water soluble, such that the liquid composition 214 dissolves in the condensate fluid 186, such that the liquid composition 214 can be configured to comprise cleaning and/or antimicrobial/disinfectant agents/materials; or
e) a gel composition 214, which can be water soluble, such that the gel composition 214 dissolves in the condensate fluid 186, such that the gel composition 214 can be configured to comprise cleaning and/or antimicrobial/disinfectant agents/materials. In related embodiment, a powder composition 214 can be configured to transform into a gel composition 214.

In a further related embodiment, the sanitation composition 214 can be a liquid composition 214 including a quaternary ammonium chloride solution.

In another further related embodiment, the sanitation composition 214 can be a powder, granulate or block/pellet composition 214 including chlorine, bromine, Biguanide, or a combination of these.

Here has thus been described a multitude of embodiments of the air-conditioning drain line sanitation device 110, and systems and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

For example, in related embodiments, the drain line sanitation device 110 may be configured for installation on a vertical drain line 194 or vertical pipe 194, for example such that the container connector 230 includes a 90 degree bend in order to maintain a vertical orientation of the container 112.

Many such alternative configurations are readily apparent and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. An air-conditioning drain line sanitation system, comprising:
a) an air-conditioning unit, comprising a drain emission connector, such that the drain emission connector is configured to emit a condensate fluid from the air-conditioning unit during operation of the air-conditioning unit;
b) a drain line, which is configured with a hollow interior to allow the condensate fluid to flow away from the air-conditioning unit via the drain line; and
c) an air-conditioning drain line sanitation device, which comprises a container, which comprises a sanitation composition, wherein the container is removably attached to the air-conditioning drain line sanitation device;
wherein the air-conditioning drain line sanitation device is connected between an outer end of the drain emission connector and a first end of the drain line to create a fluid connection between the drain emission connector and the drain line; wherein the air-conditioning drain line sanitation device is configured to mix the condensate fluid emitted from the drain emission connector with the sanitation composition, such that the sanitation composition sanitizes the condensate fluid and the drain line, whereby a risk of clogging the drain line is reduced.

2. The air-conditioning drain line sanitation system of claim 1, wherein the air-conditioning drain line sanitation device further comprises a line connector, comprising:
a) a connector pipe segment, comprising inner and outer ends, and a connector aperture in a bottom side of the connector pipe segment; and
b) a container connector, which is connected to the bottom side of the connector pipe segment, around the connector aperture;
wherein the container is removably attached to the container connector, such that an interior of the container is in fluid contact with the connector pipe segment via the connector aperture.

3. The air-conditioning drain line sanitation system of claim 2, wherein the container further comprises:
an outer enclosure, which comprises an upper opening and the interior that is accessible via the upper opening, such that an upper end of the outer enclosure is configured to detachably connect to a lower end of the container connector to create a tight lock;
such that the condensate fluid flows via the upper opening of the outer enclosure into the interior, such that the condensate fluid mixes with the sanitation composition;
whereby a flow of condensate fluid past the connector aperture in the connector pipe segment causes the condensate fluid mixed with the sanitation composition to flow back into the connector pipe segment and subsequently into the drain line.

4. The air-conditioning drain line sanitation system of claim 3, wherein the upper end of the outer enclosure is configured with an enclosure connector, which locks into the lower end of the container connector.

5. The air-conditioning drain line sanitation system of claim 4, wherein the enclosure connector is a snap-lock connector, comprising snap lock tabs.

6. The air-conditioning drain line sanitation system of claim 2, wherein the container further comprises:
a) an outer enclosure, such that an upper end of the outer enclosure is configured to detachably connect to a lower end of the container connector to create a tight lock; and
b) an inner container, which comprises an upper opening and the interior that is accessible via the upper opening, such that the inner container is configured to slide into the outer enclosure;
such that the condensate fluid flows via the upper opening of the inner container into the interior, such that the condensate fluid mixes with the sanitation composition;
whereby a flow of condensate fluid past the connector aperture in the connector pipe segment causes the condensate fluid mixed with the sanitation composition to flow back into the connector pipe segment and subsequently into the drain line.

7. The air-conditioning drain line sanitation system of claim 6, wherein the inner container comprises an upper lip and the outer enclosure comprises an upper rim, such that the upper lip rests on the upper rim.

8. The air-conditioning drain line sanitation system of claim 3, wherein the container further comprises:
a sealing plate, which is locked in place on top of the outer enclosure between the lower end of the container connector and the outer enclosure, such that the sealing plate comprises sealing apertures, to allow the condensate fluid to flow via the sealing apertures into the interior.

9. The air-conditioning drain line sanitation system of claim 8, wherein the sealing apertures each have a diameter in a range of 0.5 to 10 mm.

10. The air-conditioning drain line sanitation system of claim 1, wherein the container is made of a transparent material.

11. The air-conditioning drain line sanitation system of claim 3, wherein the line connector and the outer enclosure is made of a transparent material.

12. The air-conditioning drain line sanitation system of claim 1, wherein the sanitation composition is water soluble and comprises a disinfectant agent.

13. The air-conditioning drain line sanitation system of claim 12, wherein the sanitation composition is a powder.

14. A drain line sanitation system, comprising:
a drain line sanitation device, which comprises a container, which comprises a sanitation composition, wherein the container is removably attached to the drain line sanitation device;
wherein the drain line sanitation device is configured to connect between an outer end of a drain emission connector and a first end of a drain line to create a fluid connection between the drain emission connector and the drain line;
wherein the drain line sanitation device is configured to mix a condensate fluid emitted from the drain emission connector with the sanitation composition, such that the sanitation composition sanitizes the condensate fluid and the drain line, whereby a risk of clogging the drain line is reduced.

15. The drain line sanitation system of claim 14, wherein the drain line sanitation device further comprises a line connector, comprising:
a) a connector pipe segment, comprising inner and outer ends, and a connector aperture in a bottom side of the connector pipe segment; and
b) a container connector, which is connected to the bottom side of the connector pipe segment, around the connector aperture;
wherein the container is removably attached to the container connector, such that an interior of the container is in fluid contact with the connector pipe segment via the connector aperture.

16. The drain line sanitation system of claim 15, wherein the container further comprises:
an outer enclosure, which comprises an upper opening and the interior that is accessible via the upper opening, such that an upper end of the outer enclosure is configured to detachably connect to a lower end of the container connector to create a tight lock;
such that the condensate fluid flows via the upper opening of the outer enclosure into the interior, such that the condensate fluid mixes with the sanitation composition;
whereby a flow of condensate fluid past the connector aperture in the connector pipe segment causes the condensate fluid mixed with the sanitation composition to flow back into the connector pipe segment and subsequently into the drain line.

17. The drain line sanitation system of claim 15, wherein the container further comprises:
a) an outer enclosure, such that an upper end of the outer enclosure is configured to detachably connect to a lower end of the container connector to create a tight lock; and
b) an inner container, which comprises an upper opening and the interior that is accessible via the upper opening, such that the inner container is configured to slide into the outer enclosure;
such that the condensate fluid flows via the upper opening of the inner container into the interior, such that the condensate fluid mixes with the sanitation composition;
whereby a flow of condensate fluid past the connector aperture in the connector pipe segment causes the condensate fluid mixed with the sanitation composition to flow back into the connector pipe segment and subsequently into the drain line.

18. The drain line sanitation system of claim 17, wherein the inner container comprises an upper lip and the outer enclosure comprises an upper rim, such that the upper lip rests on the upper rim.

19. The drain line sanitation system of claim 16, wherein the container further comprises:
a sealing plate, which is locked in place on top of the outer enclosure between the lower end of the container connector and the outer enclosure, such that the sealing plate comprises sealing apertures, to allow the condensate fluid to flow via the sealing apertures into the interior.

20. The drain line sanitation system of claim 16, wherein the line connector and the outer enclosure is made of a transparent material.
